(19) United States
(12) Patent Application Publication
(10) Pub. No.: US 2004/0033380 A1
(43) Pub. Date: Feb. 19, 2004

(54) Process for the manufacture of thermoplastic shrink films

(76) Inventors: Arthur Bobovitch, D.N. HaNegev (IL); Israel Sarid, D.N. HaNegev (IL); Simha Levene, D.N. HaNegev (IL); Boris Gorelik, Tzur Hadassah (IL)

Correspondence Address: Kevin D.McCarthy, Roach Brown McCarthy & Gruber, P.C., 420 Main Street-1620 Liberty Building, Buffalo, NY, 14202, US

(21) Appl. No.: 10/601,471

(22) Filed: Jun. 23, 2003

(30) Foreign Application Priority Data
Dec. 25, 2000 (IL) 140541
Sep. 10, 2001 (WO) PCT/IL01/00854

(51) Int. Cl. B32B 27/00

(52) U.S. Cl. 428/515; 428/500

(57) ABSTRACT

A process for the production of mono- and multi-layer polymer shrink-films, wherein the composition does not include polymer cross-linking enhancers. A photoinitiator is added to a polymeric composition of which at least one layer is made, and the material is illuminated, after extrusion but before orientation, with ultraviolet radiation, to induce cross-linking within the layer or layers of the film. The amount of the photoinitiator, and the intensity and duration of the illumination are determined to provide a degree of cross-linking sufficient to create a desired change in the physical properties of the film.

### FIELD OF THE INVENTION

The present invention relates to an improved process for the manufacture of thermoplastic shrink films.

### BACKGROUND OF INVENTION

The manufacture of thermoplastic shrink-films is a well-known multistep process. Usually, pellets of a polymer are pushed through an extruder and melted to produce a planar or tubular primary, which is significantly thicker than the final product desired. This primary is cooled and reheated to the orientation temperature and stretched in one or two directions to give orientation. The stretching may be carried out in a bubble. The orientation step gives the polymer film its final thickness and, by aligning the polymer macromolecules within the film, gives the shrink film many of its useful properties.

The rheology of the melted polymer has a great influence on the orientation step. The stability of bubble formed in the orientation process is the most important factor for durable production and consistent properties. If the film is insufficiently strong at the stretching temperature, the bubble can rupture during orientation. When the tape is tubular it may weld to itself. These problems can cause batch failure and loss of productivity. Even if particular production conditions can be found for production of a given formulation, it is always desirable to have a robust production process, thereby increasing production rate and efficiency.

As a result, there exists an undesirable limitation on the polymer formulations that can be used to make shrink films. Examples of the polymer compositions for which these limitations exist include polyethylene copolymers such as ethylene vinyl acetate (EVA), ethylene methyl acrylate (EMA), ethylene ethyl acrylate (EEA), ethylene butyl acrylate (EBA) and all ethylene/alpha-olefin copolymers, like LLDPE, ULDPE and mLLDPE.

A well-known method to modify the physical properties of polymers is through the induction of cross-linking of the macromolecules within the polymer. Chemical means (e.g. adding peroxides to the feed) or irradiation (before or after orientation) can induce cross-linking of the polymer. Cross-linking changes the polymer properties, like the creep behavior, the mechanical properties at elevated temperatures, reducing stickiness and increasing the viscosity of a polymer.

U.S. Pat. No. 4,515,745 teaches that by adding virtually undetectable amounts of a chemical cross-linking agent, the bubble stability increases during the stretching of tubular EVA films. This patent does not teach the use of UV irradiation. The process described in this patent is difficult to control. Similarly, U.S. Pat. No. 4,614,764 teaches achieving increased bubble stability and improved film characteristics in linear low density polyethylene (LLDPE) when low levels of cross-linking are chemically induced.

U.S. Pat. No. 4,525,257 teaches that low level irradiation with an electron beam before extrusion induces sufficient cross-linking of LLDPE/alpha-olefin particulate copolymer to increase bubble stability despite no significant gel content. This process is relatively expensive.

U.S. Pat. No. 5,089,352 teaches that low-levels of cross-linking induced by a combination of chemical means and post-extrusion electron beam irradiation increases the viscosity of the melted polymer to a level that allows an increased production rate even when the gel content is not measurable by standard tests.

Chemically induced cross-linking occurs during extrusion. This is often disadvantageous as extrudate properties tend to fluctuate with time and batch to batch reproducibility of the ultimate film properties is more difficult to achieve. Electron beam irradiation is often used to induce cross-linking. However, the apparatus to generate electron beams is generally expensive to buy and to maintain. Electron beam radiation is also limited in that it can degrade certain polymers, e.g. vinylidene chlorides (such as Saran™) or polymers having tertiary and quaternary carbons, in macromolecular backbone.

A cheap and easy alternative to these methods which has been developed in the last years is the use of ultraviolet radiation along with photosensitizers to induce polymer cross-linking.

European Patent Application 490,854 teaches a continuous process for ultraviolet-induced cross-linking of the molten polyethlene tubing emerging from the extruder. The tubing according to this patent is not subsequently oriented, and very high concentrations of photoinitiators are required in order to achieve the required high gel percentage. The patent teaches the use of cross-linking additives such as triallylcyanurate or triallylisocyanurate as cross-linking enhancers in order to achieve this high gel percentage. These enhancers are toxic and not suitable for food-wrapping application. Benzophenone, which is commonly used as a cross-linking UV photo-initiator, is volatile, and has an unpleasant odour. The patent teaches the use of special non-volatile benzophenone derivatives developed to withstand the high extruding temperatures.

U.S. Pat. No. 5,993,922 teaches the UV cross-linking to high gel content of specific layers in multilayer shrink or other films, by the introduction of special compositions in their formulation. The latter materials are expensive.

All the above patents deal with relatively easily manageable polymers. However, the prior art methods do not enable the employment of a large number of polymers in the double-bubble process, because of the aforementioned stability problems.

It is a purpose of the present invention to provide a method to induce low-levels of cross-linking, i.e. less than 10% gel content, and thus to facilitate the orientation of the double-bubble process for polymers that were hitherto unmanageable.

It is another purpose of the invention to improve the stability of sensitive polymer compositions, and to render them more easily stretchable to allow increased output orientation, thereby to increase productivity and to reduce downtime.

It is yet another object of the invention to reliably apply shrink-film manufacturing techniques to hitherto problematic, yet desirable, polymer compositions, while maintaining or increasing the speed of production.

It is a further purpose of the present invention to allow the production of a cross-linking gradient within the film thickness, in order to produce a film where each side has different properties.

It is a still further purpose of the present invention to induce low-levels of cross-linking, i.e. less than 10% gel content, and thus to modify the properties of shrink-films while maintaining or increasing the speed of production.

It is still another purpose of the present invention to allow the easy, efficient, and inexpensive application of low levels of cross-linking, for the purpose of improving the properties of multilayer shrink-films, while maintaining or increasing the speed of production

Other purposes and advantages of this invention will become apparent as the description proceeds.

### SUMMARY OF THE INVENTION

The process for improving the production of polymer-shrink films according to the invention comprises, as a first step, adding non-volatile and highly soluble photoinitiators, for example of the type disclosed in European Patent Application No. 490,854 to the polymer feed. The photoinitiators described in EP 490,854 are of two types: I. BP-L 4-hydroxybenzophenone laurate and II. BP-S 4-hydroxybenzophenone stearate, and the present description refers to them, by reference, for the sake of brevity and convenience.

In a second step, after the extrusion and cooling of the tape in either a planar or tubular form, said tape is irradiated with ultraviolet light to induce relatively low levels of cross-linking in the tape i.e., below 10% gel content. The amount of photoinitiator and the intensity of the light are chosen such that the polymer composition will have a higher viscosity and reduced stickiness, or a combination thereof, such that orientation can be performed more easily, more quickly and under less rigorous conditions. The amount of the photoinitiator added is up to 1 weight percent (preferably 0.2%) of the feed for the layer to cross-linked. Unless otherwise specifically otherwise stated, percentages given herein are by weight.

### BRIEF DESCRIPTION OF THE DRAWINGS

FIG. 1 is a schematic representation of the double-bubble process used in a preferred embodiment of the present invention;

FIG. 2 is a schematic representation of a prior art double-bubble process;

FIG. 3 is a schematic illustration of the two-steps tenting process; and

FIG. 4 is a schematic illustration of the one-step tenting process.

### DETAILED DESCRIPTION OF PREFERRED EMBODIMENTS OF THE INVENTION

The production of a monolayer polymer film usually begins with the melting of a polymer composition, and the extrusion of the melted mass through a die to form a tape. The tape is typically planar or tubular. After cooling and solidifying, this extrudate is further processed by orientation. Orientation involves heating the tape to its orientation temperature so that it can be stretched. Stretching aligns the polymer macromolecules within the film. Planar tapes can be oriented using the tenter drawing technique where clamps stretch the film in the desired directions. Tubular tapes can be oriented using a bubble technique where air is forced coaxially into the heated tape, stretching it. It is the orientation step that gives the polymer film its shrinking and other desired properties. These techniques are well know in the art, and are therefore only mentioned here briefly.

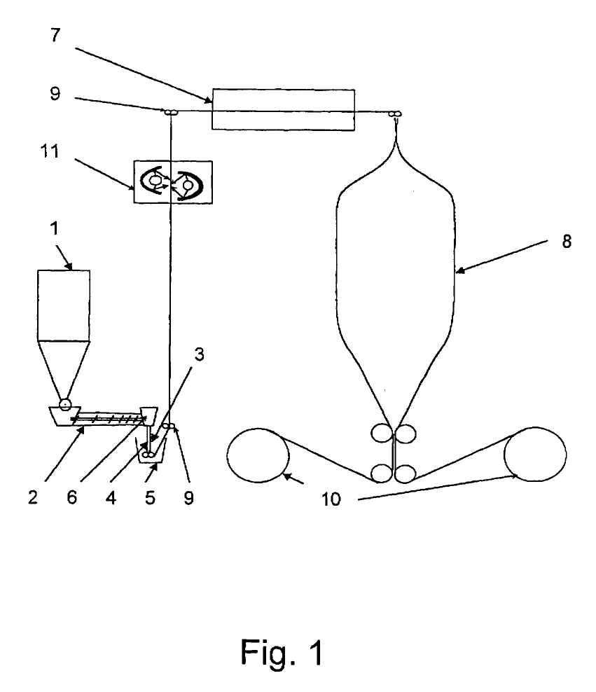

In FIG. 1 the double-bubble technique for making a film is schematically illustrated. Polymer granules from a feeder (1) are melted in an extruder (2). The melted polymer is continuously pushed through an annular die (6) to produce a tubular tape that is kept inflated by air-flowing around a mandrel to form the first bubble (3), which is externally cooled by a quenching water flow (4). After passing through a quench bath (5), the first bubble has already solidified, the tape is collapsed and transported by the use of nip rollers (9) to an oven (7), which brings the tape to its orientation temperature. Air pressure separates the inner surfaces of the tube and creates the second bubble (8). The circumference of the bubble is several-fold larger than that of the tube, and the material is oriented in the transverse direction (TD) by this stretching. In the machine direction (MD) orientation is produced by stretching the tube longitudinally, the rollers at the entrance to the stretching zone, before the bubble, rotating at a peripheral speed which is several-fold less than the exit speed. After cooling, this second bubble is axially cut and rolled onto spindles (10) for packaging and further processing (racking). According to a preferred embodiment of the invention, an ultraviolet oven (11) is added anywhere between the point of tape solidification and the second bubble.

By using a coaxial multiannular extrusion die, more than one layer can be simultaneously extruded, each layer with the same or a different polymer composition, to form a multilayer tape. The number of layers desired in the produced film determines the number of passageways in the die. The tape so produced can be further processed using the double-bubble technique to make multilayer shrink-films.

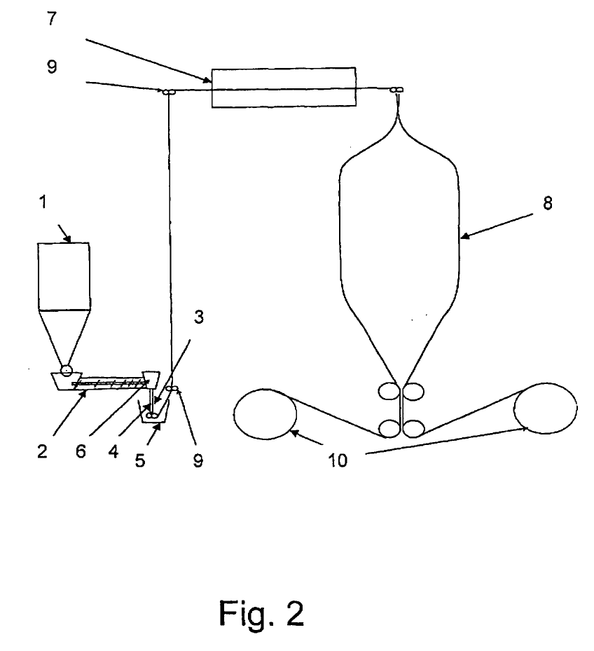

In comparison, FIG. 2 illustrates the common bubble process without the addition of UV and photoinitiators. The invention, however, is not limited to the use only in the bubble process, and can be applied in other orientation techniques including the tenter process.

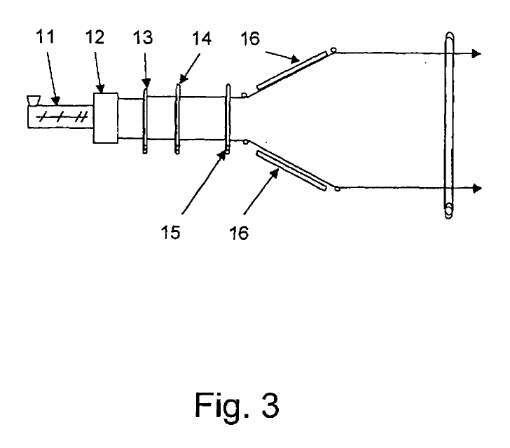

FIG. 3 schematically illustrates a two-step process, in which flat tape from the extruder (11) is subjected in the first step to longitudinal orientation between the nip rolls (13) and (14, 15). In the second step, the film enters a tenterframe, where it is stretched laterally by means of chains of grips (16).

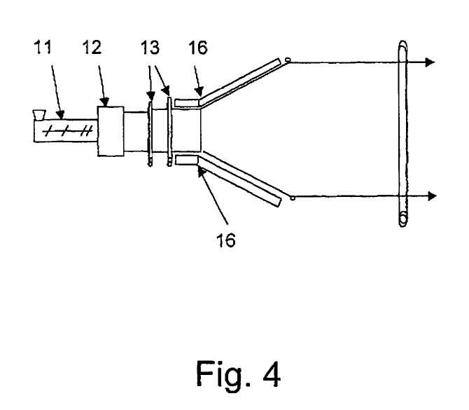

The tenter process can also be performed as single step operation, as schematically shown in FIG. 4, in which a sheet is cooled on casting rollers (13) and then biaxially oriented in a tenterframe (16) equipped with roller grips for holding and stretching bilaterally. According to a preferred embodiment of the invention, in the tenter process, the UV lamps are mounted at any position after the casting rolls (13), preferably immediately after the rolls, to facilitate orientation of complicated formulations.

According to a preferred embodiment of the invention, one or more UV sensitive photoinitiators are added to the polymer composition fed through the extruder. There are many possible UV sensitive photoinitiators known in the art. Benzophenone, benzoin and derivatives such as deoxybenzoin, hexachlorobenzoin and chlorinated polypropylene are mentioned as examples for cross-linking of polyethylene. Preferable photoinitiators are those with a high solubility in the chosen polymer composition and a low vapor pressure at the extrusion temperature. Amongst the suitable photosensitizers are those described in European Patent Application No. 490,854. The invention, however, is not limited to the use of any specific photoinitiator. Typically, but not limitatively, no more than 1 weight percent of photoinitiator needs to be added to a given polymer composition. When it is desired to produce a multilayer film, then the photosensitizer will be added to one or more of the polymer feeds.

According to a preferred embodiment of the invention, at some point after extrusion where the polymer tape has substantially solidified, it is passed through an ultraviolet oven in a non-collapsed state where it is irradiated with ultraviolet light to induce cross-linking.

According to another preferred embodiment of the invention, the tape is passed in its collapsed form through an ultraviolet oven, but care is taken that the ultraviolet light be intense enough to lead to homogenous cross-linking throughout the thickness of the collapsed tape.

The effect of cross-linking is that films made with polymer compositions that were previously not amenable to orientation become suitable for use with the double-bubble process. Bubbles expanded in the orientation are more robust and less prone to bursting, and therefore it is possible to increase the racking speed, and thus to increase productivity. Due to the reduced incidence of bubble-bursting and of welding of the tape, and to the reduced stickiness of the film, downtime is also reduced. Increased bubble robustness allows, amongst other advantages, a greater extent of stretching, enabling the production of thinner films.

According to another preferred embodiment of the invention, a monolayer film is produced with a cross-linking gradient through the film thickness. The proximal face of the film, which originates from the external surface of the tube, will have different physical properties than the distal face that originates from the inner surface of the tube. Process parameters such as irradiation intensity, photoinitiator concentration or tape speed through the ultraviolet oven, are selected such that the desired cross-linking gradient is achieved. A film with a cross-linking gradient, through its thickness, may be produced in either a double-bubble or a tenter or other processes.

According to another preferred embodiment of the invention, a multilayer film is produced wherein only some of the layers are cross-linked. In order to achieve this result, photoinitiators are added only to the feed of those layers for which cross-linking is desired. Upon passing through the ultraviolet oven, only the layers that contain photoinitiators will become cross-linked. The above can be achieved by both the double-bubble and the tenter or other processes.

The following examples illustrate the invention and are not intended to limit it in any way.

### EXAMPLE 1

A three-layer structure A/B/A having a thickness ratio of 10/80/10%, respectively, was extruded on Polytype three-layer biorientation line at a rate of 130 Kg/h, at extrusion temperatures of 200-210° C., which are common for LLPDE extrusion.

Layer A was LLDPE, density 0.920 g/cm³.

Layer B was ULDPE, density 0.902 g/cm³.

The skin layers included 97% LLPDE Dowlex 5056 ex. DOW 2.6% antiblock masterbatch (synthetic silica) and 0.4% photoinitiator type BP-L (benzophenone laurate). The core layer comprised 99.6% ULDPE PL-1880 ex. DOW with 0.4% of BP-L.

The primary tube thickness was 450 microns and it was irradiated by passing through the focal planes of 3 UV lamps from each side (total of 6 lamps), at a speed of 12 m/min. The lamps used were 240 W/cm, Nordson Ltd, medium-pressure UV lamps providing a total dosage of 0.25J per square centimeter in the UVC spectrum, which includes the 265 nm absorption line of benzophenone. The 15 microns film was obtained by orientation of the tube, after irradiation.

The test was also performed without UV irradiation. Whereas, in the presence of irradiation the bubble was stable for over 4 hours, without irradiation it was difficult to produce a bubble even for a short period. The above orientation stability could be achieved only post irradiation of the primary tube. The irradiation induced stability of the bubble. Thus, a continuous processing of the structure was practical.

A creep test was used to monitor the cross-linking, as follows: a sample of 1 cm width and 5 cm length was loaded with 15 grams weight and immersed in an thermostated oil bath, at 130° C., (above the melting point of polyethylene). The creep time for the specimen to reach elongation of 6 cm was measured. It was shown that for non-irradiated samples the creep time was less than 10 sec. For the above mentioned sample the creep time exceeded 300 sec, which was the maximum measuring time. The gel content of the film was measured to monitor the cross-linking, by extraction in Xylene for 12 hours. The gel content in the sample was found to be approximately 5%.

### EXAMPLE 2

A three-layer structure A/B/A, having a thickness ratio of 20/60/20%, respectively, was extruded using the same conditions as described in Example 1. The same polymers were used as in Example 1. The downstream processing and irradiation conditions were the same as in Example 1. UV lamp conditions were as in Example 1. The photoinitiator was BP-S (benzophenone stearate) and it was added as follows: 1% to the outer skin and 0.6% to the core layer.

The results of the creep tests were similar to those of Example 1.

The gel content of the product was approximately 7%.

During the test UV irradiation was switched off. It was found impossible to keep the bubble stable, even for a short period. The above orientation stability was achievable only by irradiation of the primary tube.

### EXAMPLE 3

A three-layer structure A/B/A was extruded, using the same materials, structure and conditions as mentioned in Example 2. However, the primary tube was irradiated with only four lamps (two from each side). The creep time was 210 sec. and the achieved gel content was 4%. A test study without the use of irradiation was performed as described in Example 2. Orientation stability could be achieved only by irradiation of the primary tube.

### EXAMPLE 4

A monolayer structure was extruded by using a Prandi monolayer extrusion and orientation line at 130 Kg/hour. The extrusion temperature profile at maximum was 210° C. The raw materials were 68% LDPE 2102 TC32 ex DSM, 30% M205 ex. DEX., 0.5% BP-L and 1.5% of antiblock concentrate.

The primary tube, 590 microns thick, was irradiated with 4 UV lamps (as in Example 3) at a linear speed of 7.2 m/min. The measured creep time was greater than 185 sec. The measured gel content was approximately 3%.

While embodiments of the invention have been described by way of illustration, it will be understood that the invention can be carried out by persons skilled in the art with many modifications, variations and adaptations, without departing from its spirit or exceeding the scope of the claims.

1. A process for improving processability of mono- and multi-layer polymer shrink-films, comprising adding a photoinitiator to a polymeric composition of which said monolayer film or at least one layer of said multilayer film is made, wherein said composition does not include polymer cross-linking enhancers, extruding said composition, illuminating said extruded composition with ultraviolet radiation, to induce cross-linking within said layer or layers of the film, the amount of said photoinitiator and the intensity and duration of said illumination being such as to provide a gel content below 10%, and submitting said composition to an orientation treatment.

2. A process according to claim 1, wherein the orientation treatment is performed using the double-bubble technique.

3. A process according to claim 1, wherein the polymeric composition is selected in the group consisting of polyethylene, ethylene copolymers, and their mixtures.

4. A process according to claim 3, wherein the ethylene copolymers are selected in the group consisting of LLDPE, LDPE, m-LLDPE, EVA, EBA, ULDPE, and their mixtures.

5. A process according to claim 1, wherein the amount of photoinitiator is up to 1 weight percent of the composition to which it is added.

6. A process according to any one of the preceding claims, wherein the film to be produced is a monolayer film.

7. A process according to any one of the preceding claims, wherein the film is a multilayer film.

8. A process according to claim 7, wherein no photoinitiator is added to one or more of the layers.

9. A process according to claim 1, wherein the cross-linked material of one layer is chosen such that it provides strength and impermeability to the film.

10. A process according to claim 9, wherein the cross-linked material(s) of one or more external layer(s) are chosen such that they provide sealability to the film.

11. A process according to claim 1, wherein the orientation treatment is performed using the tenter technique.

12. A monolayer shrink-film, which does not include polymer cross-linking enhancers and is cross-linked to the extent that it comprises a gel content below 10%.

13. A multilayer shrink-film, which does not include polymer cross-linking enhancers, in which multilayer shrink-film some of the layers are cross-linked to the extent that they comprise a gel content below 10%, and others are not cross-linked.
